(19) United States
(12) Patent Application Publication
(10) Pub. No.: US 2015/0348520 A1
(43) Pub. Date: Dec. 3, 2015

(54) Violin Cushioning Device

(71) Applicant: Shannon Tang, Ware, MA (US)

(72) Inventor: Shannon Tang, Ware, MA (US)

(21) Appl. No.: 14/291,064

(22) Filed: May 30, 2014

(51) Int. Cl. G10D 3/18

(52) U.S. Cl. CPC G10D 3/18

(57) ABSTRACT

An easily attachable and removable violin-cushioning device that contains an elongated cushion pad and two looped elastic ties for attachment to the lower body of a violin. The device attachment prevents any damage to the instrument. The cushion pad provides comfort to a player and reduces the strain of the violin against the player's neck during play. The device can be used by players of any size or shape. The device does not move during long periods or continued use. The device is small and lightweight to allow for easy storage and transport in the instrument's case.

### FIELD OF THE INVENTION

The field of the invention relates to an easily attachable and removable soft violin cushioning device with two looped elastic ties that stretch over the lower body portions of the violin to prevent movement during usage.

### BACKGROUND OF INVENTION

Violin and violas are handheld stringed instruments that produce sounds by vibrating their strings with fingers or a bow.

These instruments may be played in a horizontal position with the neck held by a player's hand and the body saddle resting on a player's chin, neck, and shoulders during play.

During long practice and performance sessions, the rubbing movement caused by the instrument causes the shoulder, clavicle, neck, and chin of the player to become irritated and uncomfortable from bruises and abrasions.

Shoulder and chest pads for use with violins and violas have been developed that serve as pillow-like members which accommodate and support the instrument comfortably to the individual violinist's shoulder and chest.

Such prior pads are limited to only a few positions, so that the violinist usually had to compromise his or her comfort. Furthermore, some of the prior pads engaged a substantial portion of the underside of the violin thus partially absorbing and muffling the violin sound, affecting the tonal quality and resonance of the instrument.

Some of these pads consisted of air-filled bladders that needed to be inflated before use, and sometimes re-inflated during long performance sessions. These bladder pads could also leak, which could damage the instrument, or disrupt a performance.

Other prior pads are composed of rigid materials, such as metal or hard plastics with padding attached. The rigid materials can damage the instrument. Most of these supports are also large and bulky, making it difficult for a player to find a place inside the instrument case to store the support. These larger types of supports, being of unyielding materials, may also pose a hazard to the player, causing fixed and unnatural playing positions that can lead to neck and back problems for the player. They are also commonly rather heavy which adds to the weight of the instrument. Such additional weight is a detriment to players who have the instrument in a playing position many hours a day.

Another problem with previous pads is their tendency to move upon the instrument with rubbing movement of the musician, requiring frequent readjustment.

Finally, the prior pads do not sufficiently address the irritation and abrasions caused by the end pin, the lower bout ribs, the lower bout purfing edges, and other lower end protrusions of the violin against a player's neck during long practice and performance sessions.

Despite the fact there are numerous and various types of shoulder and chest pads that can be found in the prior art, there nevertheless exists the need for an improved neck cushioning device which permits a musician to comfortably hold a stringed instrument such as a violin for long periods of time. The ideal device should be light weight, easy to attach to the instrument, easy to store in the instrument case, remain in place for long periods of use, be comfortable, not distract the musician, accommodate various physical variations of a musician, and mount on the instrument in a manner so it will not scratch or otherwise damage the instrument.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses a neck cushioning device for a violin, viola, a fiddle, or a likewise instrument, the device comprising: an elongated, stretchable cushion pad with two ends, wherein the cushion pad comprises a soft, pliable material; a single closed-looped elastic tie on each end of the cushion pad; wherein the device is removably attached to the violin by looping each elastic tie around a lower outturned corner, over a lower bout purfling edge, and a front lower body of the violin; further wherein the elongated cushion pad is configured to stretch and substantially complementary fit to lower bout ribs, lower bout purfling edges, an end pin, and a tail gut of the violin; wherein the cushion pad provides cushioning to a player's neck and chin during use of the violin; and wherein the device does not substantially move during use of the violin.

In a further embodiment of the subject invention, the cushion pad further comprises a soft cover composed of a material selected from the group consisting of: fabrics, leather, and vinyl plastic.

In another embodiment of the subject invention, the cushion pad further comprises a polurethane foam.

In other embodiments of the subject invention, the device does not physically adhere to the violin, viola, or fiddle.

In a further embodiment of the subject invention, the device does not substantially damage the violin, viola, or fiddle during attachment.

In another embodiment of the subject invention, the device is useable by players of any age.

In a further embodiment of the subject invention, the device is removably attachable to violins, violas, or fiddles of any size.

In other embodiments of the subject invention, the device comprises a size and weight that is stored in a violin, viola, or fiddle case along with the instrument.

In embodiments of the subject invention, the term “substantially” is defined as at least close to (and can include) a given value or state, as understood by a person of ordinary skill in the art. In one embodiment, the term “substantially” refers to ranges within 10%, preferably within 5%, more preferably within 1%, and most preferably within 0.1% of the given value or state being specified.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. These together with other objects of the invention, along with the various features of novelty, which characterize the invention, are pointed out with particularity in the claims annexed to and forming a part of this disclosure.

### BRIEF DESCRIPTION OF THE DRAWINGS

Advantages of the present invention will be apparent from the following detailed description of exemplary embodiments thereof, which description should be considered in conjunction with the accompanying drawings:

FIG. 1 is a top perspective view of a violin cushioning device.

FIG. 2 is a top view of the violin cushioning device.

FIG. 3 is a side view of the violin cushioning device.

FIG. 4 is another side view of the violin cushioning device.

FIG. 5 is a top perspective view of the violin cushioning device attached to the lower bout ribs, lower bout purfling edges, end pin, saddle, and tail gut of a violin.

### DETAILED DESCRIPTION OF EMBODIMENTS

The following will describe, in detail, several embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

For a conceptual understanding of the invention and its operational advantages, refer to the accompanying drawings and descriptive matter in which there are preferred embodiments of the invention illustrated. Other features and advantages of the present invention will become apparent from the following description of the preferred embodiment(s), taken in conjunction with the accompanying drawings, which by way of example; illustrate the principles of the invention.

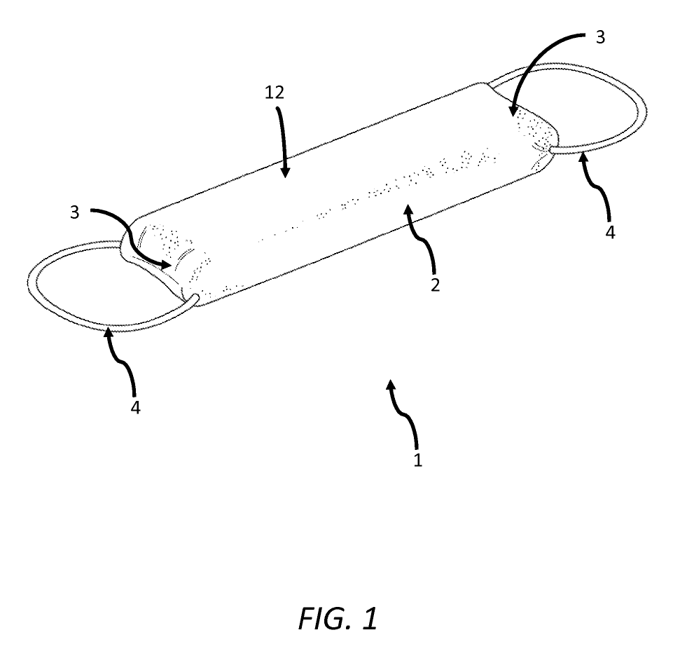

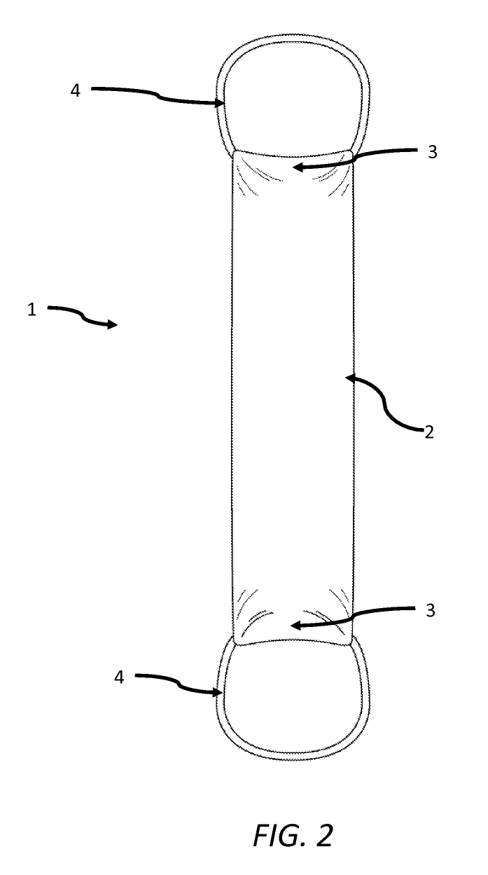

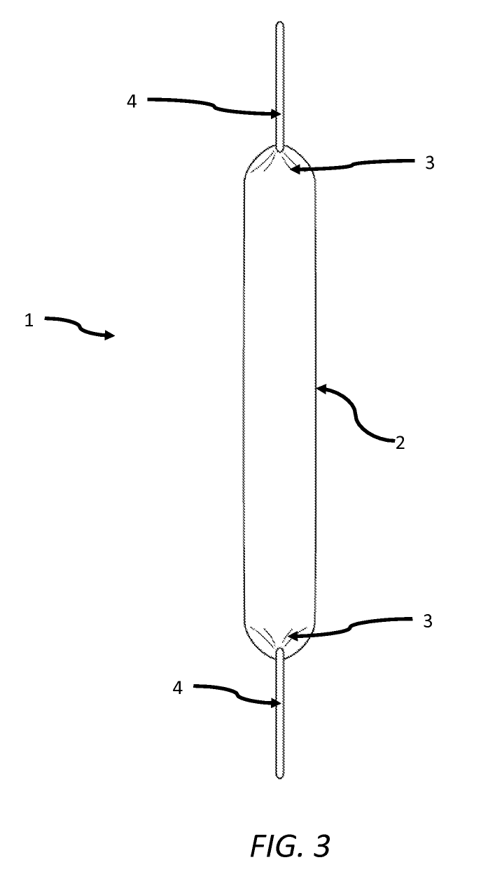

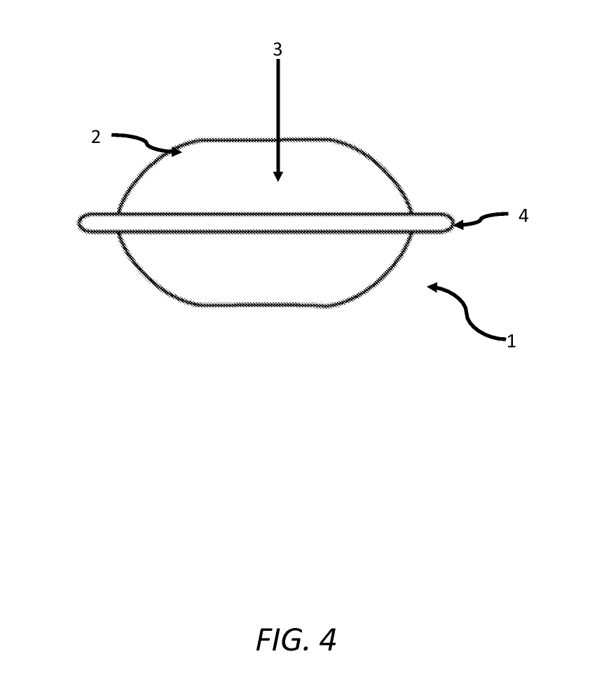

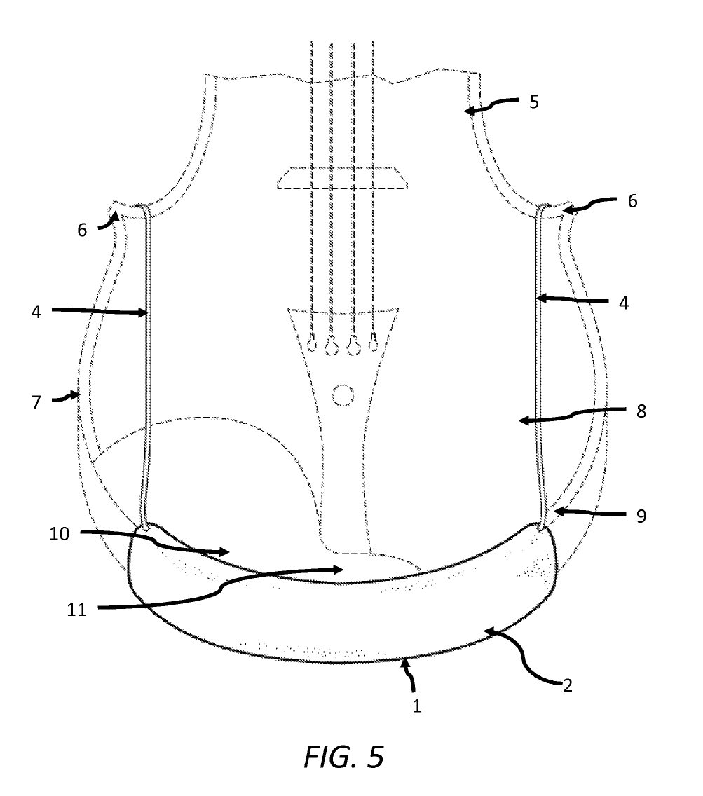

The subject invention, illustrated in FIGS. 1-5, is easily attachable and removable soft violin-cushioning device 1. The device 1 comprises a narrow, elongated cushion pad 2 with two ends 3, each containing a looped elastic tie 4. Each looped elastic tie 4 is attached to the violin 5 by looping around a lower outturned corner 6 over the lower bout purfling edges 7 and the front lower body 8 of the violin 5. The cushion pad 2 is configured to stretch and snugly fit over the lower bout ribs 9, lower bout purfling edges 7, end pin (not shown), the body saddle 10, and tail gut 11 of a violin 5 without the need for screwing, adhering, or clipping the device 1 onto the violin 5. This form of attachment prevents any damage to older, more sensitive instruments. The device 1 mounts on the violin 5 in a manner that does not scratch or otherwise damage the instrument.

The cushion pad 2 contains a soft exterior layer 12 that may be composed of soft fabrics, leather, or vinyl plastic. The interior of the cushion pad 2 may contain soft foams, such as polyurethane foam.

The cushion pad 2 provides comfort to a player and reduces the strain of the lower bout purfling edges 7 of the violin 5 against the player's neck and chin during play. The device 1 can be used by players of any size or shape. The two looped elastic ties 4 and the snug fit of the cushion pad 2 against the over the lower bout ribs 9, lower bout purfling edges 7, end pin (not shown), the body saddle 10, and tail gut 11 of a violin 5 prevents the device 1 from movement during long periods or continued use.

The device 1 can be easily removed from the violin 5 by unlooping the ties 4 from the lower outturned corners 6. The device 1 is small and lightweight to allow for easy storage and transport in the instrument's case.

The small mass of the foam pad adds virtually no weight to the instrument. The invisibility of the filament and the insignificance of the elastic band together with the method of attachment combine to make a support that is not visually distracting to an audience.

A unique feature of the invention is that the rest will accommodate various size instrument such as 1/2-4/4 violins and 12-16 violas. Various sizes of the rest can be provided to accommodate a range of players from young students to adults.

The many aspects and benefits of the invention are apparent from the detailed description, and thus, it is intended for the following claims to cover such aspects and benefits of the invention, which fall within the scope, and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A neck cushioning device for a violin, the device comprising:
an elongated, stretchable cushion pad with two ends, wherein the cushion pad comprises a soft, pliable material;
a single closed-looped elastic tie on each end of the cushion pad;
wherein the device is removably attached to the violin by looping each elastic tie around a lower outturned corner, over a lower bout purfling edge, and a front lower body of the violin;
further wherein the elongated cushion pad is configured to stretch and substantially complementary fit to lower bout ribs, lower bout purfling edges, an end pin, and a tail gut of the violin;
wherein the cushion pad provides cushioning to a player's neck and chin during use of the violin; and
wherein the device does not substantially move during use of the violin.

2. The cushioning device of claim 1, wherein the cushion pad further comprises a soft cover composed of a material selected from the group consisting of: fabrics, leather, and vinyl plastic.

3. The cushioning device of claim 1, wherein the cushion pad further comprises a polurethane foam.

4. The cushioning device of claim 1, wherein the device does not physically adhere to the violin.

5. The cushioning device of claim 1, wherein the device does not substantially damage the violin during attachment.

6. The cushioning device of claim 1, wherein the device is useable by players of any age.

7. The cushioning device of claim 1, wherein the device is removably attachable to violins of any size.

8. The cushioning device of claim 1, wherein the device comprises a size and weight that is stored in a violin case along with the violin.

9. A neck cushioning device for a viola, the device comprising:
an elongated, stretchable cushion pad with two ends, wherein the cushion pad comprises a soft, pliable material;
a single closed-looped elastic tie on each end of the cushion pad;
wherein the device is removably attached to the viola by looping each elastic tie around a lower outturned corner, over a lower bout purfling edge, and a front lower body of the viola;
further wherein the elongated cushion pad is configured to stretch and substantially complementary fit to lower bout ribs, lower bout purfling edges, an end pin, and a tail gut of the viola;
wherein the cushion pad provides cushioning to a player's neck and chin during use of the viola; and
wherein the device does not substantially move during use of the viola.

10. The cushioning device of claim 9, wherein the cushion pad further comprises a soft cover composed of a material selected from the group consisting of: fabrics, leather, and vinyl plastic.

11. The cushioning device of claim 9, wherein the cushion pad further comprises a polurethane foam.

12. The cushioning device of claim 9, wherein the device does not physically adhere to the viola.

13. The cushioning device of claim 9, wherein the device does not substantially damage the viola during attachment.

14. The cushioning device of claim 9, wherein the device is useable by players of any age.

15. The cushioning device of claim 9, wherein the device is removably attachable to violas of any size.

16. The cushioning device of claim 9, wherein the device comprises a size and weight that is stored in a viola case along with the viola.
